(19) United States
(12) Patent Application Publication
(10) Pub. No.: US 2016/0148192 A1
(43) Pub. Date: May 26, 2016

(54) METHOD AND SYSTEM FOR MULTICURRENCY TRANSACTIONS

(71) Applicant: REVOLUT LTD., London (GB)

(72) Inventor: Nikolay STORONSKY, London (GB)

(21) Appl. No.: 14/549,837

(22) Filed: Nov. 21, 2014

(51) Int. Cl. G06Q 20/34; G06Q 20/40; G06Q 20/38; G06Q 20/20; G06Q 20/10; G06Q 20/36

(52) U.S. Cl. CPC G06Q 20/351; G06Q 20/105; G06Q 20/3678; G06Q 20/381; G06Q 20/204; G06Q 20/40

(57) ABSTRACT

A system or method of operating a user held multicurrency card in a transaction with a seller operating in a first currency (first currency?); the system or method comprising: a card capable of being read by a reader; an e-wallet associated with the card and holding data relating to the card, a plurality of amounts of a plurality of currencies stored on e-wallet; a back-end system for receiving card data from the reader and a payment amount required by the seller via a network and for interfacing with the e-wallet to enable authorization of any payments; wherein in use the back-end system receives the data from the reader for a transaction and determines if the e-wallet has sufficient money in the first currency to settle the transaction and if so authorizes settlement of the payment amount.

The present invention relates to a method and system for multicurrency transactions, particularly, but not exclusively using a multicurrency card.

Nowadays there are many people living and working in an international world. People are travelling to many different countries and surfing the internet across the world. As a result people are looking to pay for goods and services with different currencies. Long gone are the days of travelers checks and foreign exchange, instead credit cards and applications on handheld devices are the means of paying for many things. Existing credit, debit and prepaid cards allow a cardholder to make payments abroad. However, the card typically has a single currency and requires currency conversion for transactions in a foreign currency. Accordingly, if a purchase is made in a different currency, the cardholder is left with some uncertainty as to the actual price of the purchased item or service in the cardholder's currency.

In addition, there is nearly always a delay between authorization of a transaction and its settlement through the banking network. As a result the cardholder will not know the exact billing amount until sometime after the purchase. This can often be anything from 2 days to a week. In the case where the purchase is of significant value, even a small fluctuation in the exchange rate between the purchase date and settlement date in the cardholder's currency could lead to a large differential in the actual cost of the transaction to the cardholder.

Another detrimental factor, which may affect the cardholder is the application of FX-padding by the card issuers. FX-padding is a percentage increase of the billing price to protect the card issuer from the situation where the settlement price is higher than authorization price. This may in some situations result in a negative card balance.

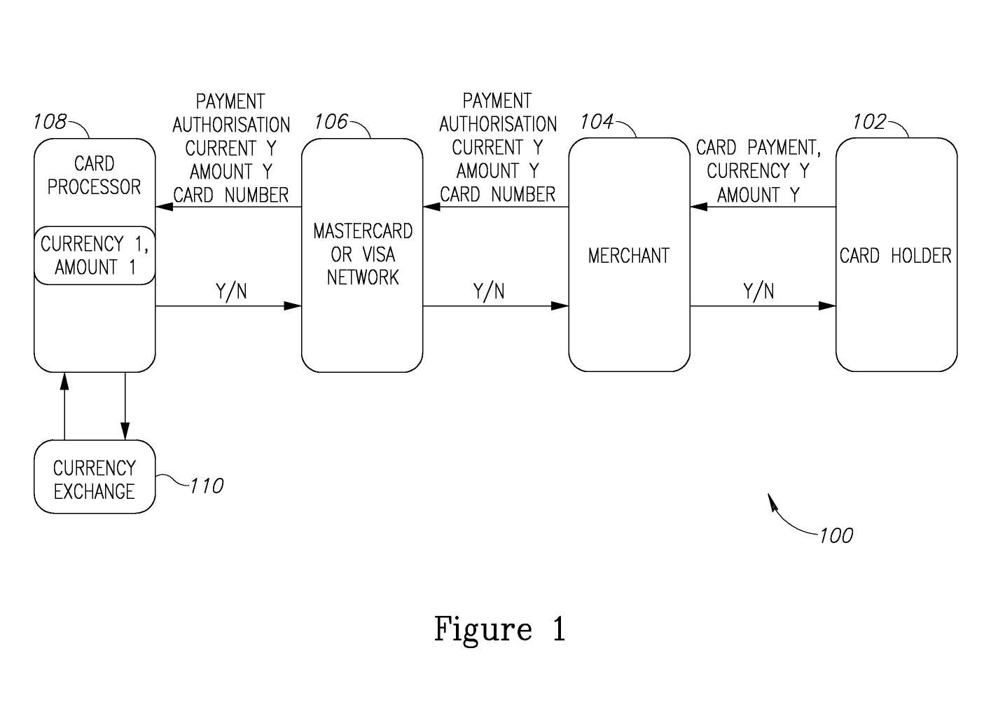

FIG. 1 is a block diagram showing a common single currency card system 100 which is used when a cardholder 102 makes a payment at point-of-sale 104 with details of transaction being passed by a card network module 106 to a card processor module 108. The card processor module authorizes transactions based on a currency value and other information stored either on the card or separate from the card. The authorization is based on predetermined rules. An issuing bank will later attend to any required currency conversion via a currency exchange module 110. The transaction is then settled and funds are transferred from the cardholder to the seller. As a result, the cardholder does not have any visibility of the exchange rate, as the exchange and settlement processes occur after authorization. Also there are often one or more foreign exchange fees (both from card network provider and the issuing bank). Thus the cardholder may not really know what he/she has paid until a statement is received.

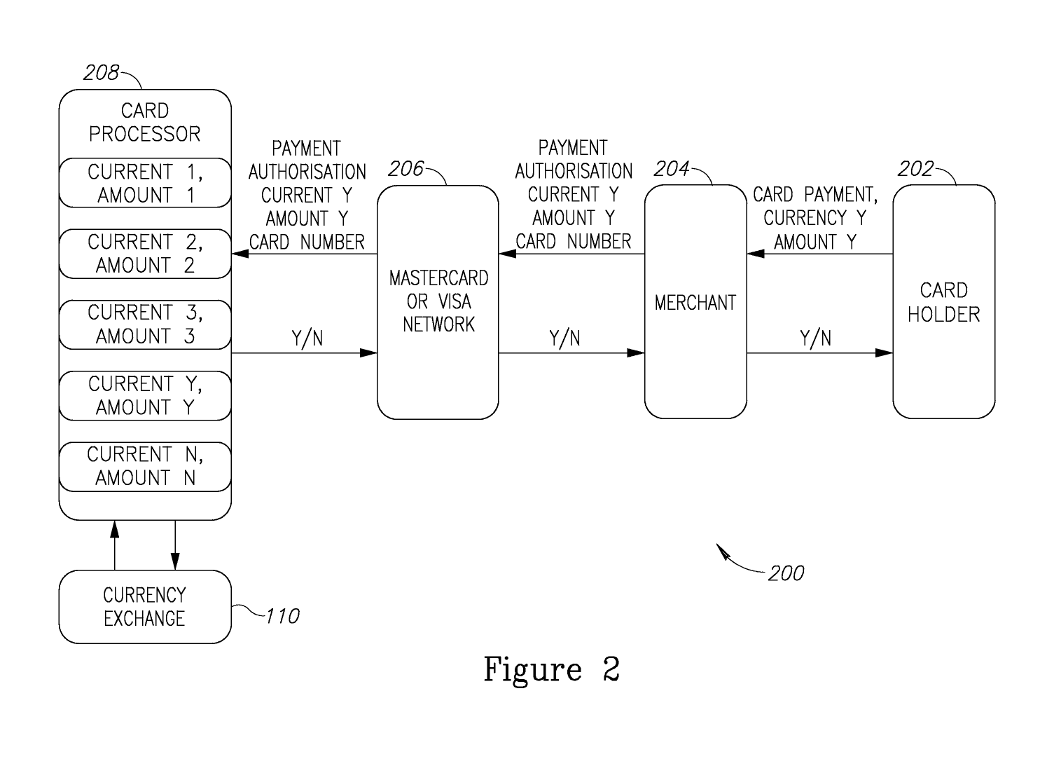

FIG. 2 is a block diagram of a prior art multicurrency card payment system 200. A multicurrency card held by a cardholder 202 has values stored at card processor module 208, for each currency the card supports and the cardholder has loaded. A cardholder 202 makes a payment at point-of-sale 204 with details of the transaction being passed by a card network module 206 to the card processor module 208. There is a set of predetermined authorization rules defined by the card processor module which relate to, for example, currencies, load limits, velocity limits etc. Currency exchange is managed by the currency exchange module 210. A problem with this method is that it limits the number of currencies available to a cardholder and does not allow flexibility of choosing in which currency to pay. This type of system also fails to support the use of so called Crypto-currencies.

Cardholders are often confused as to how the transaction amount is derived and are often uncertain as to whether the amount reflects competitive exchange rates or even whether the amount bears any relation to the original transaction. The cardholder is often charged one or more fees by the card issuer, card processor and card network for exchange services for each transaction.

The overall result of the current processes for dealing with multicurrency transactions is less than ideal for both the cardholder and indeed the whole banking service behind each transaction. A need exists for a better process for dealing with multicurrency transactions.

One object of the present invention is to overcome at least some of the problems associated with current day processes and systems for multicurrency transactions.

A further object of the present invention is to process multicurrency transactions with a multicurrency card to avoid currency conversion costs and risks associated with the delays between transaction authorization and transaction settlement.

According to one aspect of the present invention there is provided a system of operating a user held multicurrency card in a transaction with a seller operating in a first currency; the system comprising: a card capable of being read by a reader; an e-wallet associated with the card, the user and a plurality of amounts of a plurality of currencies stored thereon; a back-end system for receiving card data from the reader and a payment amount required by the seller via a network and for interfacing with the e-wallet to enable authorization of any payments; wherein in use the back-end system receives the data from the reader for a transaction and determines if the e-wallet has sufficient money in the first currency to settle the transaction and if so authorizes settlement of the payment amount.

An embodiment may further comprise, if the e-wallet has not got sufficient money to settle the transaction, automatic conversion of an amount from a second currency to the payment amount in the first currency and authorizing settlement of the payment amount in the first currency.

In an embodiment the e-wallet is connected to a currency exchange module to effect any currency exchange required in settling the payment amount.

In an embodiment the user can select the currency to be used for the transaction at the time of the transaction.

In an embodiment the back-end system instigates settle payment amount via a bank.

In an embodiment the authorization and the settlement of the payment amount are notified to the seller via the network.

In an embodiment the currency may include virtual, crypto- or alternative currencies.

In an embodiment the card may be a virtual card.

In an embodiment the card is a card function device.

In an embodiment the card data comprises a token, a key, face recognition data, voice recognition data, fingerprint data or eye recognition data.

According to a second aspect of the present invention there is provided a method of operating a user held multicurrency card in transactions with a seller operating in a first currency, wherein the card is associated with an e-wallet which holds data relating to the card, the user and a plurality of amounts of a plurality of currencies stored thereon and wherein the e-wallet interfaces with a back-end system; the method comprising: reading a card at a point of sale; transferring data from the point of sale to the back-end system via a network and card processor, at the back-end system, receiving card data from the point of sale and a payment amount required by the seller, interfacing with the e-wallet associated with the card to enable authorization of any payments; such that in use the back-end system receives the data from the reader for a transaction and determines if the e-wallet has sufficient money in the first currency to settle the transaction and if so authorizes settlement of the payment amount.

In an embodiment if the e-wallet has not got sufficient money to settle the transaction, automatically converting an amount from a second currency to the payment amount in the first currency and authorizing payment amount in the first currency.

In an embodiment connecting the e-wallet to a currency exchange module to effect any currency exchange required in settling the payment amount.

In an embodiment the user selecting the currency to be used for the transaction at the time of the transaction.

In an embodiment instigating settling the payment amount via a bank.

In an embodiment notifying the authorization of the payment amount to the seller via the network.

In an embodiment the currency may include virtual, crypto- or alternative currencies.

In an embodiment the card may be a virtual card.

In an embodiment the card is a card function device.

In an embodiment the card data comprises a token, a key, face recognition data, voice recognition data, fingerprint data or eye recognition data.

According to a third aspect of the present invention there is provided a card for use in the system of the first aspect.

According to a fourth aspect of the present invention there is provided an e-wallet for use in the system of the first aspect.

In an embodiment the e-wallet is linked to the card of the third for use in a multicurrency transaction.

The present invention will now be described, by way of example, to the accompanying drawings in which:

FIG. 1 is the block diagram of a common prior art system with single currency card;

FIG. 2 is the block diagram of a prior art system with multi-currency card transactions facilities;

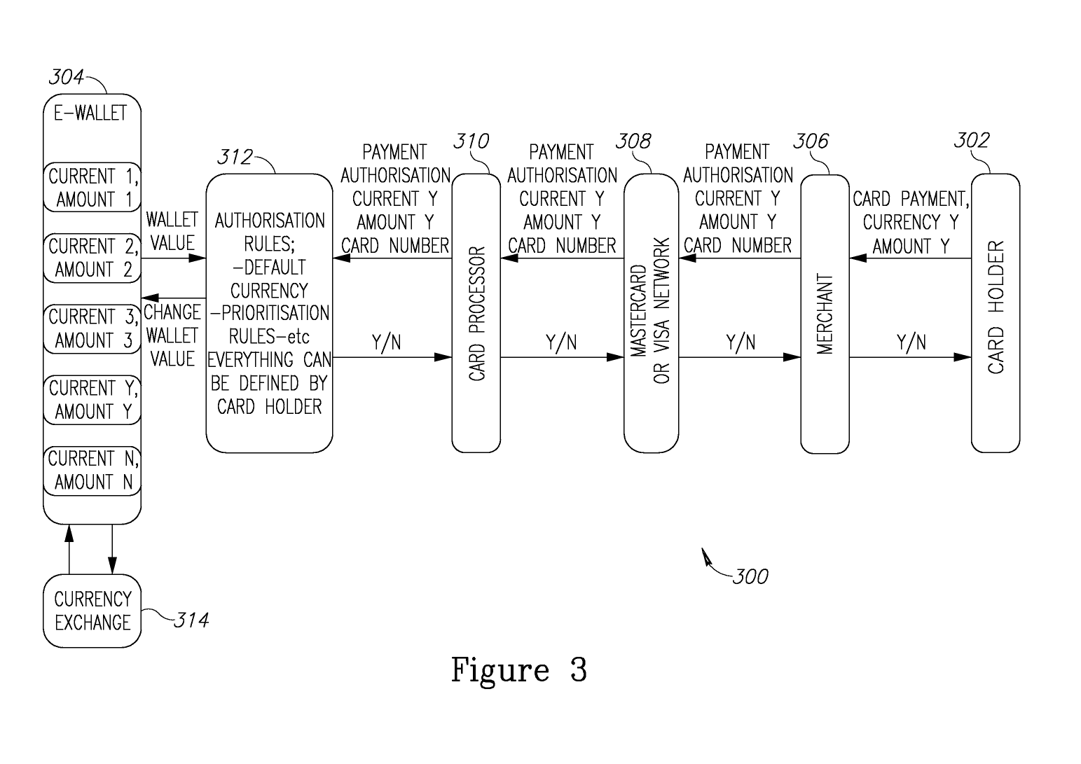

FIG. 3 is a block diagram of a multi-currency card transaction system linked to a multicurrency e-wallet, according to an embodiment of the present invention;

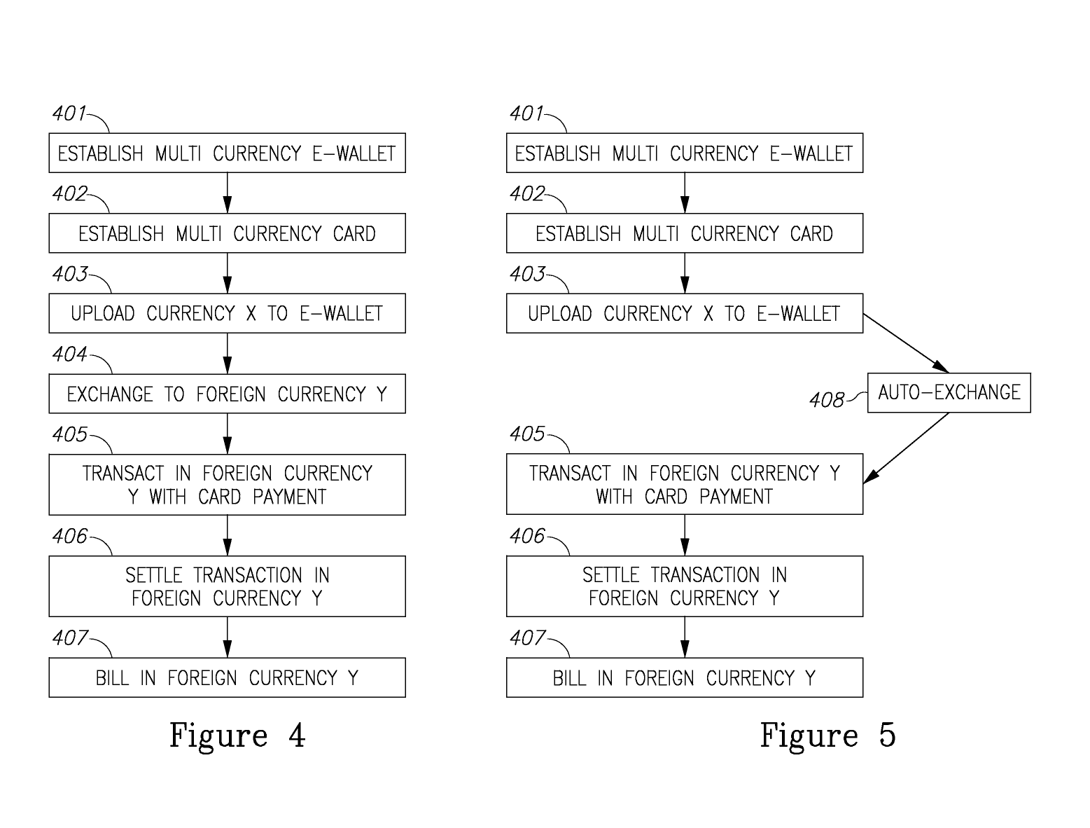

FIG. 4 is a flow diagram of a method for managing multicurrency balances of a user, according to an embodiment of the present invention;

FIG. 5 is a flow diagram of a further method for managing multicurrency balances of a user, according to an embodiment of the present invention; and

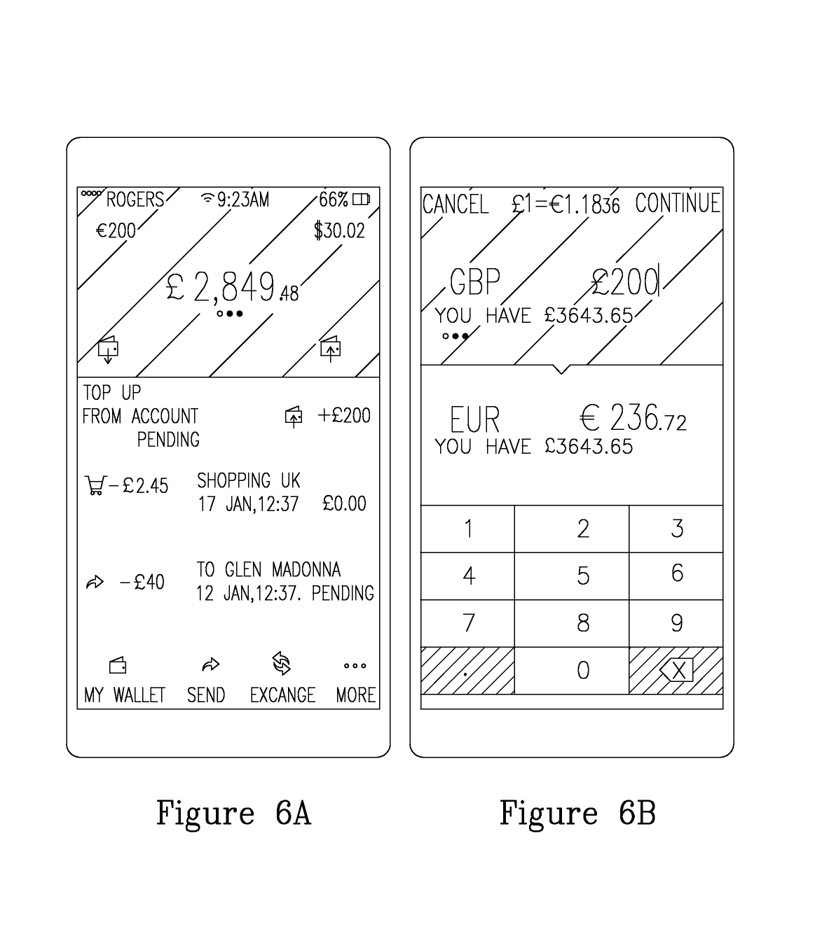

FIGS. 6A and 6B are representations of various interfaces included in the sequence of FIGS. 4 and 5, according to an embodiment of the present invention.

In broad terms, the present invention relates to payments made through a multicurrency card linked to a multicurrency e-wallet. The system and method allows a cardholder to pay for goods or services using a currency that is most favorable to the user under the circumstances of a particular transaction or group of transactions. For example, if a user is intending to be in Europe during a given month, he/she can upload any currency to the multicurrency e-wallet and change it to Euros during that given month so that the user can make payments directly in Euros while in Europe, rather than converting from Pounds to Euros at the point-of-sale. The system allows the user to specify almost any rule to determine which currency is used to pay. The system can even be adapted to operate with a crypto-currency such as, for example, BitCoin™ or Ripple™.

The method of performing a card transaction between a cardholder and a merchant or seller takes place in a currency that the cardholder chooses at the point-of sale. The method further includes uploading any currency to the e-wallet; exchanging it to the desired currency at a time that suits the cardholder and carrying out one or more transactions in the desired currency through the multicurrency card associated with the e-wallet. If required the method may also include an auto-exchange function. If a user has £100 in the GBP wallet and $0 in the USD wallet and the customer is making a trip to the USA and wishes to make a $50 transaction, at the moment of authorization, the USD wallet is increased by $50 and the GBP wallet is reduced by the equivalent of $50. As a result the transaction is authorized even though there was a zero balance in the USD wallet.

FIG. 3 is a block diagram of multicurrency card transaction system 300 in accordance with an embodiment of the present invention. A multicurrency card is held by a cardholder 302 and has a card number issued under a Bank Identification Number (BIN) that allows settlement in multiple currencies. The currencies may be any currency throughout the world, for example those currencies supported by the MasterCard or Visa networks. The system also includes an externally held e-wallet 304 that essentially holds customer balances in different currencies for the use of the cardholder. The e-wallet in FIG. 3 is shown having N sections which can each hold an amount of money or balance in a different currency, for example currency 1, amount 1; currency 2, amount 2 etc. The card in the possession of the cardholder does not store any value on it. Instead the card has information to enable accessing the e-wallet as described below to enable the cardholder to make purchases or carry out transactions.

When the cardholder uses the card, a merchant terminal 306 passes information about the transaction to a card network module 308. The card network module may be replaced by any network that provides two-way information movement between the merchant and the e-wallet. The existing card network is used at present for convenience. The merchant terminal may be a card reader or any other appropriate reader for obtaining information from the card necessary for the transaction. In the case of a virtual card, the reader may be adapted accordingly to read whatever means of communication is used by the reader and/or the cardholder. For example a bar code reader, a scanner or any other appropriate type of reader. It should be noted that the term virtual card is not intended to be in any way limitative. The card can essentially act as a token or authorization key for the e-wallet. The token or key is information that is passed to the back-end system to enable identification of the user and authorization of any transaction that meets with the necessary rules and approvals associated with that token or key and the associated e-wallet. Authorization can occur without a card or any other physical interface, such as face, voice, finger print or eye recognition. All that is needed is the unique user token or key which may be an alphanumeric combination, or any other appropriate information.

The information passed from the merchant terminal to the back-end system may include: the card number, the currency, the amount and any other information which is relevant to the cardholder, merchant or transaction which may be needed to process the transaction. The card network module may be housed by one of the major credit or debit card companies, such as MasterCard or Visa. The card network module 308 then directs the information to a card processor module 310. The card processor module requests payment authorization from a back-end system 312. The back-end system then authorizes payment based on cardholder-defined rules and the e-wallet balance.

The card processor module and the back-end system are elements which allow a cardholder to access the e-wallet and means that the authorization is not in the hands of the card network or card processor system. Instead the card network system receives all the necessary authorizations from back-end system. This ensures that the cardholder can make payment in the currency required without additional cost. The card processor module and the back-end system can be housed in any suitable locations, such as for example, a bank, a remote service center or any other appropriate location. The card processor module is essentially an interface between the back-end system and the card network module. Receiving information from the card network module and passing authorizations or denials from the back end system.

The cardholder-defined rules can be different from one user to the next and may include common rules which apply to all users. For example not allowing a user to spend over a certain amount in a certain time period may depend on the funds in the e-wallet and may be different for each user. Other rules may relate to required balances, overdraft or credit rules, spending rules, rules relating to access to the balance in the e-wallet etc.

If necessary the cardholder can exchange e-wallet balances in different currencies with an interface connected to a currency exchange module 314. This may be useful if a user has spent all of one type of currency but still wishes to make more purchases in that currency. In this case funds can be transferred from one currency to another on the e-wallet. In an example if the cardholder is in Europe and is making purchases in Euros and exceeds the amount in the Euros section of the e-wallet, subject to rules that do not prevent it, the system may use funds from another section of the e-wallet. For example, if the cardholder has enough dollars to cover the purchase, the system will exchange an amount from the dollars section that corresponds to the Euro amount required to make the purchase. The exchange rate can be based on instant FX spot rates.

The multicurrency card can be implemented on or as a card function device carrying out the functions of a card, that can be held by the user and which is capable of identifying the user so that the e-wallet can release funds. The card function device retains some other identifying information but would not require the physical, plastic components typically used to read the card at a card terminal. Instead, a multicurrency card user accesses the merchant terminal in an appropriate manner, to exchange the information necessary to effect the transaction. The merchant terminal may be a kiosk, a telephone, and/or an internet-enabled personal computer. The card function device may be in the form of an application on a hand held device or may be alphanumeric data which is exchanged with the merchant terminal. The information used to identify a user and to be input to the merchant terminal may include, by way of example, speech, typing or keying of symbols, QR-codes, bar codes, fingerprint, eye print or any appropriate type of biometric identification.

For the avoidance of doubt, the term card as used in this specification is not intended to be limited to a plastic card, but is intended to include all types of card function devices as well.

As previously mentioned the cardholder can pay with any existing currency, including crypto-currencies and other currency representations.

The method gives rise to a number of advantages from which the cardholder can benefit. These include the ability of a cardholder to lock-in favorable exchange rates before a transaction occurs. Also the cardholder is not exposed to different exchange rates between authorization and settlement. There are no currency conversion fees such as those associated with single currency card. The cardholder knows the exact amount that will be paid from the e-wallet at the moment of the transaction. The cardholder can easily select to pay in a preferred currency, a crypto-currencies or any other alternative currency as the case may be.

The multicurrency card is effectively a key for passing information about any transaction to the e-wallet. The back end system, in conjunction with information in the e-wallet, authorizes the transaction and settlement based on cardholder-defined rules.

FIG. 4 is a flow diagram describing the process for using the multi-currency e-wallet and the multi-currency card linked thereto from the user point of view. The cardholder is allocated a multi-currency e-wallet 401 and issued with a multi-currency card 402. A set of user defined rules are generated at issue. These can be updated and added to from time to time as the user requires. Other rules may be put in place by the system. The user uploads a currency X to e-wallet 403 and if necessary makes an exchange to a required foreign currency Y 404. At the moment of a transaction 405 settlement and billing currencies are the same. As a result billing 407 is instant and the settlement amount 406 is equal to the billing amount. In general, the steps in FIG. 4 are carried out in or by the back-end system although this can be changed as required. For example issuance of a card is instigated by the back-end system, but the manufacture and sending of the card (in the case of a plastic card) is carried out elsewhere. However, in the case of a virtual card, all steps may be carried out by the back-end system. Other steps may be carried out in conjunction with different modules, for example, if settlement requires the movement of money from the e-wallet to a merchant bank account, it may require the cooperation of various modules outside the system as will be known to those skilled in the art. The combination and cooperation of different modules will depend on the nature of the operation in question.

FIG. 5 is a flow diagram showing the steps which occur when a cardholder uploads currency X to e-wallet 403 but does not make an exchange to a foreign currency on the e-wallet. The cardholder is allocated a multi-currency e-wallet 401 and issued with a multi-currency card 402. A set of user defined rules are generated at issue. These can be updated and added to from time to time as the user requires. Other rules may be put in place by the system. At the moment of transaction a currency exchange 408 takes place automatically. The e-wallet balance is decreased for currency X and increased for currency Y according to the spot FX rate. The remaining steps 405, 406 and 407 take place as described with reference to FIG. 4. The automatic currency exchange means the user can use funds from any of the sections of the e-wallet and convert the currency therein to the currency required for the transaction. As a result, it is possible to pay with crypto-currencies or any other existing currencies or values through existing card networks by using multi-currency card.

FIGS. 6A and 6B show a representation of an e-wallet interface. The interface may show the multiple amounts in different currencies held in the e-wallet and the transactions in different currencies (FIG. 6a). The exchange interface shown in FIG. 6b displays a current exchange rate for conversion between two currencies.

The method and system will work for any payment device, for example a physical or virtual card, a mobile phone, a biometric or voice recognition mechanism or any appropriate device.

The method and system according to the various embodiments of the present invention provides multicurrency transactions with a multicurrency card which avoids currency conversion costs and risks associated with the delay between transaction authorization and transaction settlement. Card transactions are authorized externally (i.e. outside the existing card network system). Each card is linked to a multicurrency e-wallet, which is linked to the back-end module, which forms part of the system. The monies held in the e-wallet and the other data stored thereon are outside the existing card network system. As a result, the cardholder is able to pay in any currency at the point-of-sale, including the billing currency of a merchant. This avoids exchange costs and makes the process optimal for the cardholder, merchant or seller and all the involved parties in the background.

The combination of the e-wallet and the multicurrency card in conjunction with the card processor module takes over the role of ensuring quick and effective payment for goods and services in any currency for the cardholder without any hidden costs or risks.

It will be appreciated that the system and method has been described with reference to a number of different embodiments. These embodiments are not intended to be limitative and many variations are possible which will still fall within the scope of the present invention. The invention may be implemented in software, hardware or any combination thereof. Elements that are now illustrated as software can be changed to equivalent hardware elements and vice versa.

1. A system of operating a user held multicurrency card in a transaction with a seller operating in a first currency; the system comprising:
a card capable of being read by a reader;
an e-wallet associated with the card, the user and a plurality of amounts of a plurality of currencies stored thereon;
a back-end system for receiving card data from the reader and a payment amount required by the seller via a network and for interfacing with the e-wallet to enable authorization of any payments;
wherein in use the back-end system receives the data from the reader for a transaction and determines if the e-wallet has sufficient money in the first currency to settle the transaction and if so authorizes settlement of the payment amount.

2. A system according to claim 1, further comprising, if the e-wallet has not got sufficient money to settle the transaction, automatic conversion of an amount from a second currency to the payment amount in the first currency and authorizing settlement of the payment amount in the first currency.

3. A system according to claim 1, wherein the e-wallet is connected to a currency exchange module to effect any currency exchange required in settling the payment amount.

4. A system according to claim 1, wherein the user selects the currency to be used for the transaction at the time of the transaction.

5. A system according to claim 1, wherein the back-end system instigates settlement of the payment amount via a banking payment network.

6. A system according to claim 1, wherein the authorization and the settlement of the payment amount are notified to the seller via the network.

7. A system according to claim 1, wherein the currency may include virtual, crypto- or alternative currencies.

8. A system according to claim 1, wherein the card may be a virtual card.

9. A system according to claim 1, wherein the card is a card function device.

10. A system according to claims 9, wherein the card data comprises a token, a key, face recognition data, voice recognition data, fingerprint data or eye recognition data.

11. A method of operating a user held multicurrency card in transactions with a seller operating in a first currency, wherein the card is associated with an e-wallet which holds data relating to the card, the user and a plurality of amounts of a plurality of currencies stored thereon and wherein the e-wallet interfaces with a back-end system; the method comprising:
reading a card at a point of sale;
transferring data from the point of sale to the back-end system via a network,
at the back-end system, receiving card data from the point of sale and a payment amount required by the seller,
interfacing with the e-wallet associated with the card to enable authorization of any payments; such that in use the back-end system receives the data from the reader for a transaction and determines if the e-wallet has sufficient money in the first currency to settle the transaction and if so authorizes settlement of the payment amount.

12. A method according to claim 11, further comprising, if the e-wallet has not got sufficient money to settle the transaction, automatically converting an amount from a second currency to the payment amount in the first currency and authorizing settlement of the payment amount in the first currency.

13. A method according to claim 11, further comprising connecting the e-wallet to a currency exchange module to effect any currency exchange required in settling the payment amount.

14. A method according to claim 11, further comprising the user selecting the currency to be used for the transaction at the time of the transaction.

15. A method according to claim 11, further comprising instigating settling the payment amount via a banking infrastructure.

16. A method according to claim 11, further comprising notifying the authorization and the settlement of the payment amount to the seller via the network.

17. A method according to claim 11, wherein the currency may include virtual, crypto- or alternative currencies.

18. A method according to claim 11, wherein the card may be a virtual card.

19. A method according to claim 11, wherein the card is a card function device.

20. A system according to claim 19, wherein the card data comprises a token, a key, face recognition data, voice recognition data, fingerprint data or eye recognition data.

21. A card or e-wallet for use in the system of claim 1.

22. A card according to claim 21, in the form of a card function device.

23. An e-wallet according to claim 21, for use in a multicurrency transaction.
